(19) United States
(12) Patent Application Publication
(10) Pub. No.: US 2007/0230451 A1
(43) Pub. Date: Oct. 4, 2007

(54) Communication link for rotating turret

(76) Inventors: Zvi Porat, Rishon-LeZion (IL); Dvir Besserglik, Kiryat-Ono (IL)

Correspondence Address: Martin D. Moynihan;PRTSI, Inc., P.O. Box 16446, Arlington, VA, 22215, US

(21) Appl. No.: 11/723,842

(22) Filed: Mar. 22, 2007

Related U.S. Application Data
(63) Continuation-in-part of application No. PCT/IL05/01009, filed on Sep. 21, 2005.

(30) Foreign Application Priority Data
Sep. 22, 2004 (IL) 164226

(51) Int. Cl. H04L 12/50; F41H 5/20; B23K 11/24

(52) U.S. Cl. 370/357; 307/112; 89/36.13

(57) ABSTRACT

Communication system for a rotating turret having a plurality of electronic components, comprises: a first aggregated communication link connecting between the turret and external electronics, and a first internal communication switch located within the turret for connecting each of the plurality of electronic devices to a channel of the aggregated communication link.

### RELATED APPLICATIONS

This Application is a continuation-in-part of PCT Patent Application No. PCT/IL2005/001009, filed on Sep. 21, 2005 which claims the benefit of Israel Patent Application No. 164226, filed on Sep. 22, 2004, the contents of which are hereby incorporated by reference.

### FIELD AND BACKGROUND OF THE INVENTION

The present invention relates to a communication link for a rotating turret and, more particularly, but not exclusively to a communication link for an observation turret designed to house observation equipment and to be fully and freely rotatable in order to track targets even if the turret is mounted in a rapidly moving vehicle and/or the target is moving rapidly and freely.

Observation turrets typically house one or more observation devices such as video cameras, FLIR cameras, LASER devices, and the like. The resulting video signals are very data intensive and need to be transferred to a computer or the like for processing. The current architecture of such observation systems is to have the observation systems in the turret and data processing and other computational systems outside the turret with data links of the necessary capacity in between. Thus very little processing takes place within the turret and data rates out of the turret need to be relatively high in order to accommodate real time video signals.

In particular the processing involves feedback loops. The observation turret tracks targets by imaging the target and using feedback to follow the image, or to stabilize the turret. The processing for feedback takes place outside the turret, but a short time constant is essential for effective feedback. Thus the video data has to be extracted from the turret in real time, and processed in real time, and a return signal to operate the turret's servo-motors has to be made available all in real time. Any modification that makes this time constant longer has to be resisted.

Typically each of the devices in the turret has its own data connection. The different devices that can be fitted together into a single turret are not required to be compatible in terms of communications requirements and this widens the choice of available devices for using together in the turret. Some of the devices may be AC devices, others DC devices. The servo-motors for example may use pulse width modulation (PWM) for their control signals. Some devices may use analog signals and some may use digital signals.

The data connections for the various devices in the turret need to remain functional despite free rotation of the turret, and yet rotation of the turret can lead to twisting of conventional wire connections. Each connection therefore uses a slip ring to link between the in-turret observation apparatus and the out-of turret data processing apparatus. Unfortunately slip rings are limited life components, which are often the cause of system failure and require regular maintenance. Furthermore there are only a limited number of slip rings that can be inserted into a single turret system and so the number of observation devices that can be inserted into the turret is limited. The capacity for slip rings thus limits the scope for upgrading of the turret. The number of slip rings is limited by physical space and also by weight. Slip rings are relatively heavy and expensive components and even a very small number of devices in the turret may require tens of electrical connections. It will be appreciated that weight is an important issue when the turret is intended to be mounted on an aircraft, and especially if the turret is to be mounted on a drone, which may be quite small.

Reference is now made to FIG. 1, which is a simplified diagram showing the two-part system arrangement for a rotatable observation turret. A turret 10 is fully rotatable and includes four axis servo-control 12 to control rotation. One or more sensor devices 14 such as FLIR devices, laser devices, video cameras and the like are typically mounted in the turret. Each of the sensor devices 14 receives a control input and produces an output. A computer or the like is located in an electronics box 16 located outside the turret, and, as will be appreciated, the turret rotates in use but the box does not. The various devices in the turret have different communication requirements and standards. Thus a video camera has a very high data rate output and may produce either an analog or a digital signal depending on the kind of camera. The servo control is part of a control and stabilizing system, and using signals from a gyro or the like, or from real time image processing from the cameras. The servo control part of the system produces a narrow band control signal, typically based on pulse width modulation (PWM), which operates servo-motors in the turret.

In addition to the observation devices and stabilizing devices, there are also environmental control devices for stabilizing the environment inside the turret 10. For example there may be a fan, connected in a control loop with a temperature sensor.

As the devices are all incompatible, each device has its own connection or connections to the outside world. As the turret 10 is fully and freely rotatable, each connection uses its own slipring. The slipring connections are part of an overall turret slipring arrangement 18. The turret slipring arrangement has only limited capacity for additional sliprings and therefore provides a limit to the number of devices that can be inserted into the turret. Furthermore the need to include a new slipring for a new device makes installation a complex operation. Indeed, as sensors become more and more miniaturized, the possibility arises of fitting more and more sensors into the physical confines of the turret. The limiting factor is the capacity for adding more rotatable connections and slip rings, and not the physical space in the turret.

The electronics box 16 comprises position and motion control circuits for operation of the servomotors and rotation of the turret, management circuitry for the video devices and other sensors, and MMI management circuitry which is used for handling user commands such as movement, focus, zoom, BIT etc.

The electronics box, which is typically part of the underwing pod on which the turret is mounted, is connected to a control panel 20, an operating screen 22 and to other external systems as appropriate. The control panel and operating screen may be located in the cockpit of an aircraft to allow on board control. Alternatively they may be located at a remotely located control center.

There is a widely recognized need for, and it would be highly advantageous to have, a communication link for a rotating turret which is devoid of the above limitations.

### SUMMARY OF THE INVENTION

According to one aspect of the present invention there is provided a communication system for a rotating turret having a plurality of electronic components, the system comprising:

a first aggregated communication link, for carrying a high data rate, connecting between said turret and external electronics, and

a first internal communication switch located within said turret for connecting each of said plurality of electronic devices to a channel of said aggregated communication link.

Preferably, said first communication switch manages respective channels for said plurality of electronic devices.

Preferably, some of said plurality of devices are connected to outward channels for passing data from said devices to said external electronics, and some of said plurality of devices are connected to inward channels for passing data from said external electronics to said devices.

Preferably, said first communication link is further configured with a power connection to provide power to said plurality of devices within said turret.

Preferably, said first communication link is a wired link having a slip ring connection.

Preferably, said first communication link is provided in parallel with a power connection for providing power to said turret.

Preferably, said first communication link is a wireless link.

Preferably, said communication system is any one of a group comprising an IR link, a microwave link, an optical link, a LASER link, an ultrasound link, and a radio link.

Preferably, said power connection comprises a slip ring.

Preferably, said rotating turret is a turret configured to be free to carry out unlimited rotations in a given sense.

In one embodiment, said rotating turret is a turret suitable for carrying out observations from a vehicle.

The vehicle may be an airborne vehicle, an airborne platform, a waterborne craft, or a land craft, and more particularly a fixed wing aircraft, a helicopter, an unmanned aerial vehicle, a balloon, a ship, a hovercraft, a hydrofoil, a boat, a submarine, an unmanned water craft, a tank, an armoured car, a reconnaissance vehicle, or an autonomous land vehicle such as a robot.

Alternatively, said turret is configured within a stationary installation.

The stationary installation may be any one of a watchtower, a mast, a lookout post, a bunker, a border post, and an electronic fence.

Preferably, said electronic components comprise observation devices.

Preferably, said observation devices are one or more of a radar device, a LASER-based observation device, a video camera, a still camera, a FLIR device, and an image intensifier.

The turret may comprise a first external communication switch for routing between said communication link and said external electronics.

Preferably, said external electronics are configured for carry out processing of image data from said electronic components.

Preferably, said electronic components comprise at least one observation device and at least one turret rotation device and wherein a feedback loop over said aggregated communication link is formed to use processed image data to modify a position of said turret.

Preferably, said first aggregated communication link is a digital communication link. As mentioned it is suitable for carrying a high data rate or for carrying broadband or wideband data or for carrying high speed data, and references herein to high data rate, high speed data, broadband and wideband are to be understood accordingly.

Preferably, said first aggregated communication link comprises an optical fibre.

Preferably, said optical fibre is a monomode fibre.

Preferably, said first internal communication switch comprises multiplexing functionality for multiplexing signals from said electronic devices onto respective channels.

In an embodiment, said first internal communication switch comprises demultiplexing functionality for demultiplexing signals from said channels to be routed to respective devices.

Preferably, said first external communication switch comprises multiplexing functionality for multiplexing signals from said external electronics onto respective channels for intended ones of said electronic devices.

Preferably, said first external communication switch comprises demultiplexing functionality for demultiplexing signals from said channels to be routed to said external electronics.

Preferably, said first communication link is a control link for passing control signals, and wherein there is provided a second communication link, having a second internal communication switch, for passing video signals outwardly from said turret to a second external communication switch.

According to a second aspect of the present invention there is provided a method of communicating between a plurality of electronic components in a rotating turret and external electronics in a relatively non-rotating exterior, the method comprising:

connecting each of said plurality of electronic devices to a communication switch internal to said rotating turret,

connecting said communication switch to a aggregated communication link connecting the interior of said rotating turret to said relatively non-rotating exterior,

connecting said aggregated communication link to said external electronics in said relatively non-rotating exterior, thereby to provide respectively continuous communications channels between each device, said aggregated communication link and said external electronics. Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified block diagram showing the electronic system arrangement for a prior art rotatable turret;

FIG. 2 is a simplified block diagram showing an electronic system arrangement for a rotatable turret according to a first embodiment of the present invention;

FIG. 3 is a simplified schematic diagram of a pod having a turret and a base and showing internal and external switches and a single data link therebetween, in accordance with a preferred embodiment of the present invention,

FIG. 4 is a simplified diagram showing connections to the inner and outer switches in accordance with a preferred embodiment of the present invention, and

FIG. 5 is a simplified diagram showing separate control and video links each with separate inner switches and separate outer switches, in accordance with a preferred embodiment of the present invention.

### DESCRIPTION OF THE PREFERRED EMBODIMENTS

The present embodiments comprise an observation turret having a communication switch located within the turret and connected to the various observation and servo devices. The switch in turn is connected to an aggregated data link, typically a wideband digital data link, and typically having a high data rate, which connects between the turret itself and the external world. The switch permits all of the devices in the turret to use separate channels on the same data link for communication, and the result is a more robust turret system with a much reduced need for connections. The wideband link may be a wireless link such as radio or IR or microwave or ultrasound or an optical link or the like. Alternatively it may be a wired link or a link using waveguides. The number of slip rings is greatly reduced and additional devices can be added at will as long as there is space in the turret, and capacity at the switch and over the link. No additional rotating connections are needed when adding new components.

The principles and operation of a turret system according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

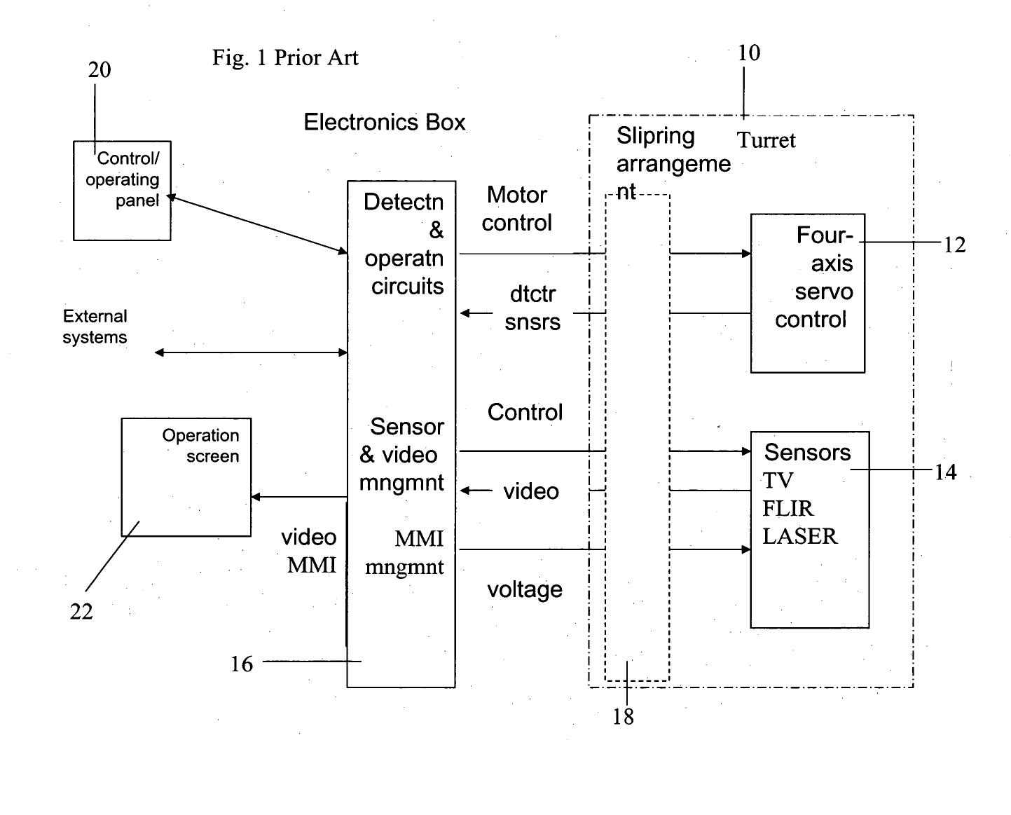

Reference was made above to FIG. 1, which illustrates the two part electrical system arrangement for a currently known observation turret or turret for any other purpose. As explained, the arrangement requires multiple rotary connections with separate slip rings, and is limited in the number of devices it can support. It is also limited in its ability to support devices that require multiple connections, for example devices intended to be connected to a parallel databus.

It is noted that rotating turrets may be for stationary mounting, say at hilltop observation platforms, on watchtowers, on masts, on lookout posts, bunkers, at border posts, and on electronic fences, including border walls, prison walls and the like.

Alternatively rotating turrets can be used in all kinds of airborne craft including fixed wing aircraft, helicopters, unmanned aerial vehicles (UAVs) of all kinds, space-borne craft, waterborne craft including ships, hovercraft, hydrofoil craft, boats, submarines etc. and land vehicles such as tanks, armoured cars, unmanned robots, reconnaissance vehicles and the like.

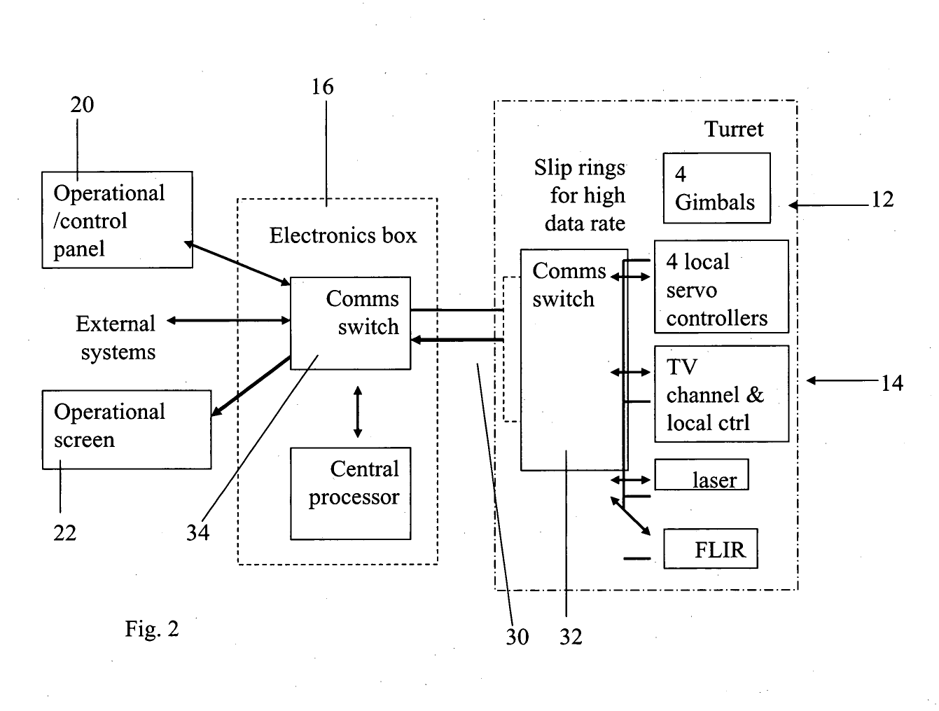

Reference is now made to FIG. 2, which illustrates the electrical system arrangement for a rotatable turret according to a first preferred embodiment of the present invention. Parts that are the same as in FIG. 1 are given the same reference numerals and are not referred to again except as necessary for understanding the present embodiment. Turret 10 again has a servo control system 12 which may include a plurality of servo control devices, and a series of observation devices 14. It also includes an aggregate communication link 30 which connects between the turret and external electronics such as electronics box 16, and furthermore has an internal data or communication switch 32, which is located within the turret and which connects to each of the electronic devices in the turret and digitizes or otherwise renders their signals compatible with the communication link 30, and then sets up channels on the link as required for each of the devices. That is to say, if the link is a digital link and any of the devices produce analog output, then the switch includes an A/D converter. A digital link is preferred as it is easier to multiplex channels together.

The link preferably has the overall broadband capacity, and sufficiently high data rate, to manage all of the devices and the switch has sufficient processing power to provide say a video camera with a broadband output channel and a stability sensor with a narrow band output channel. Having a communication switch within the turret goes against the general trend in the art which favors carrying out all processing externally.

A second data communication switch 32 is located at the external end of the link to digitize signals going towards the turret as necessary, and provide them with channels, and also to extract outgoing signals from the link and direct them to the appropriate devices or ports outside of the turret.

An advantage of the single link is that all that is needed is a rotatable connection for the data link and a second rotatable connection to provide a power supply to the internal environment of the turret. If the link 30 is a wireless link of some kind then the only rotatable connection that is needed is for a power supply to provide electrical power to the turret. In either case the total number of slip rings needed is minimal, ideally just two, hence reducing the likelihood of failure within the system and furthermore new devices may be added to the turret as long as there is capacity on the link, without the need to introduce an additional slip ring. Regarding the question of capacity it is noted that the typical communication switch has a buffer, allowing less critical data to be queued, so that the link need only provide an average system capacity, not a peak capacity.

Suitable candidates for a wireless link include an IR link, a microwave link, an optical link, a LASER link, an ultrasound link, and a radio link. Alternatively, as mentioned above, a wired or waveguide link can be used. Typical observation devices likely to be placed inside a turret include both active and passive observation devices, for example radar of different wavelengths, a laser-based observation device, a video camera, a still camera, a FLIR device, and an image intensifier.

Use of a digital link makes it simple to use a digital video camera, for example using Mpixel or HDTV formats. The format in which the data is produced at the camera may be retained over the link and fed as is to the video card at the external electronics for real time display with minimal intermediate processing. It may be added that the use of a digital signal format across the link preserves the integrity of the image to a greater extent than the prior art analog systems.

In addition it is possible to place a local digital controller on each pivot of the rotatable turret. The controllers may close a local control loop to provide say stability to the turret whilst obtaining target finding and tracking instructions from the electronics box 16 via the link 30.

As the signal received from the link is digital, the complexity of the processing circuits in the image processing cards that receive and process the image data is reduced, since there is no need to digitize the signals at the card, in contrast with the prior art.

For the same reason, data recording is simplified. The actual data as provided by the link 30 can be recorded in a digital memory, whether magnetic, solid state or any other and/or can be transmitted to a remote location for remote viewing, processing or storage using existing digital communication infrastructure.

Digital image data, depending on the format, can be output directly to the screen. The data can be displayed on LCD screens and the computer can be relieved of the burden of the display task.

A particular advantage of the single data link of the embodiment of FIG. 2 concerns the rapidly increasing numbers of miniature sensors. With the current art, the limit on the number of devices in the turret has nothing to do with the size or complexity of the devices but rather with the number of connections needed. Thus the rotating turret has been unable to benefit from the increasing miniaturization of numerous kinds of sensors. With the single aggregated preferably digital link of the present embodiments, the only barriers to the number of sensors that can be inserted into the turret is the physical space in the turret, connection capacity in the switch, and the overall data capacity in the link. For example micro-electro-mechanical systems (MEMS) sensors can be inserted at will to provide high levels of stability and navigability for very little extra weight.

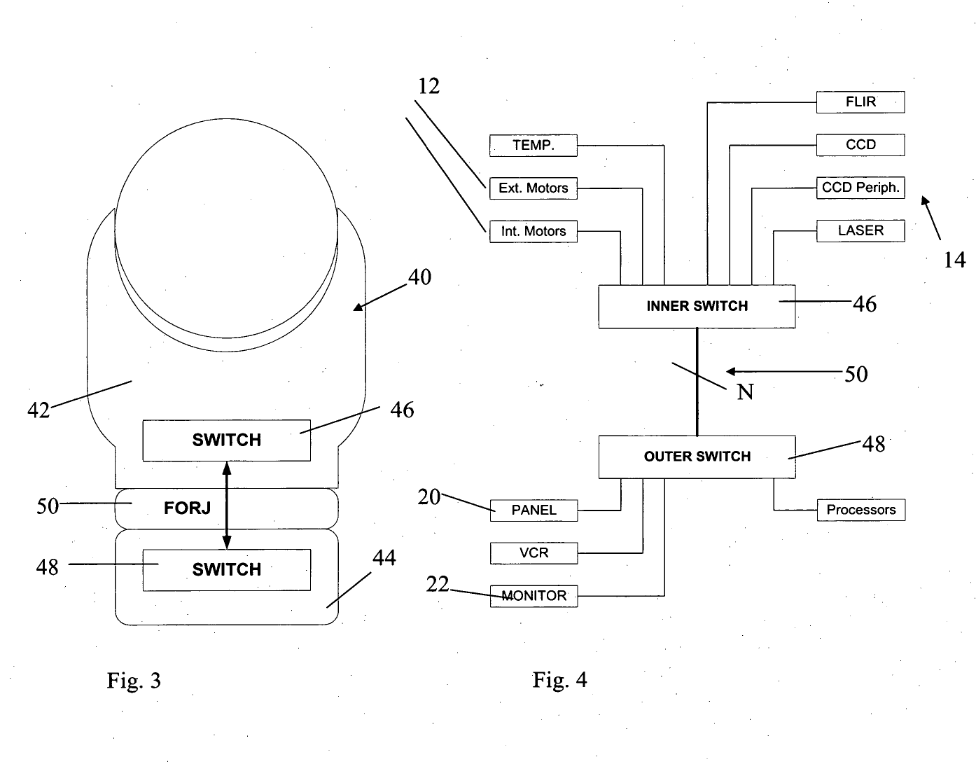

Reference is now made to FIG. 3, which is a simplified schematic diagram showing a turret with two switch units and a multi-channel link in between, according to a preferred embodiment of the present invention. A pod 40 comprises a turret 42 and base 44. Turret 42 has a first or internal communication or data switch 46, which is as described above. A second external communication or data switch 48 lies in the base 44 and in between the two switches is a multi-channel data link 50. In the embodiment of FIG. 3 the link is an optical link using optical waveguides. The optical link may be a single multimode fibre or multiple single mode fibres as convenient. Reference is now made to FIG. 4, which is a simplified block diagram illustrating connections to the two switches. Parts that are the same as in previous figures are given the same reference numerals and are not referred to again except as necessary for understanding the present embodiment. Devices, sensors and motors, 12 and 14, inside the turret 10 are connected to the internal switch 46. Processors, control and display panels and the like are connected to external switch 48 and the two switches are linked, as described above by an aggregated data link 50.

In a preferred embodiment the capacity of the link 50 is of an order of magnitude greater than the capacity at the output side of the switch. In a first example of capacity requirements, on the assumption of a 50 MBPS compressed video signal from a video camera, which signal has to be combined with control and other signals, a 100 MBPS output capacity at the switch is sufficient but the link should be 1 GBPS, say using GigE (Gigabit Ethernet). In a second example, for a non-compressed video output, say 0.3 GBPS, a 1 GBPS output can be used with a 10 GBPS link.

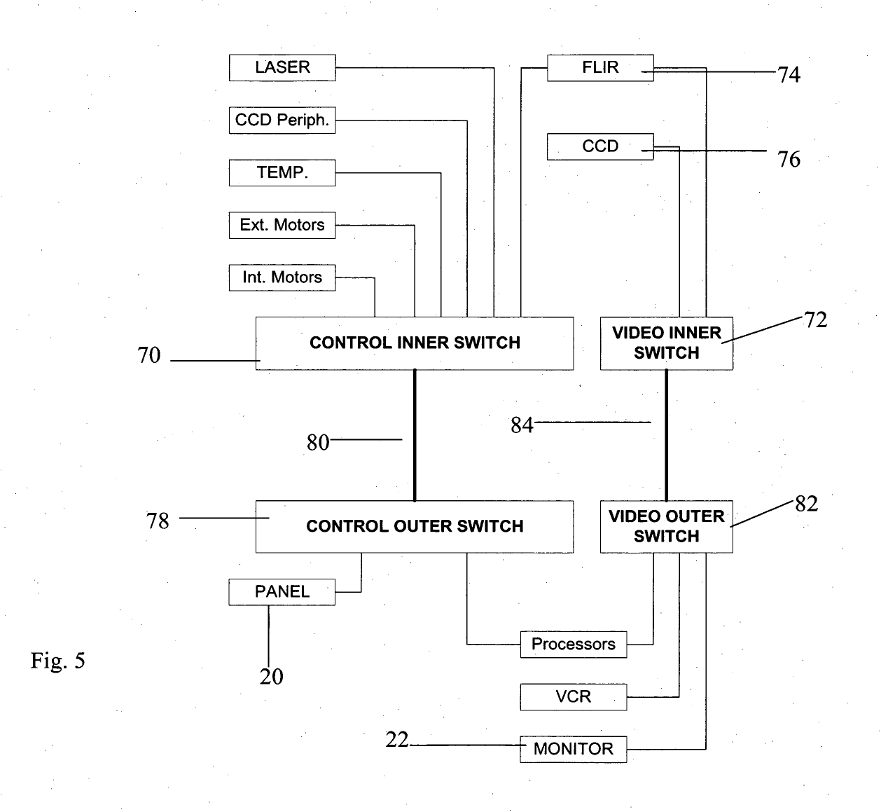

In a separate embodiment it is possible to provide two separate links, one high capacity link for the video and one smaller link for the control and other system traffic. The second embodiment is illustrated in FIG. 5, which is similar to FIG. 4 but the previous inner switch is now split into a control inner switch 70 and a video inner switch 72. All devices in the turret are connected to the control inner switch and those that give a video output, here FLIR 74 and CCD 76, are additionally connected to the video inner switch. A control outer switch 78 is connected via control link 80 to the control inner switch 70, and video outer switch 82 is connected via video link 84 to video inner switch 72.

In the case of FIG. 5, the above examples work as follows:

In the first example, on the assumption of a 50 MBPS compressed output signal from a video camera, which signal no longer has to be combined with control and other signals, a 100 MBPS output capacity at the switch is sufficient but the link should be 1 GBPS, say using GigE. In a second example, for a non-compressed video output, at a higher level of 0.5 GBPS, a 1 GBPS output can be used with the same 10 GBPS link as before. In addition the control link 80 is preferably provided, in either case with 100 MBPS at the switch output and 1 GBPS in the link itself.

Video is typically transmitted digitally, and preferred formats include DVS 50, DVS 25, MPEG 4 (H.261, H.264), sent using RPT packets over UDP/IP. The remaining signals can be transmitted using RS-232, RS-422, RS-485 digital signaling in discrete transmission channels for each major component, using TCP/IP packets.

The video signals are preferably multicast so that they can be received by multiple receiving devices. Control signals from the processors to the turret can also be multicast, as they can be received by multiple devices as necessary. The control signals from the turret to the processors, including servo processors, are preferably unicast.

It is expected that during the life of this patent many relevant observation devices and systems, and turret mounted components and systems will be developed and the scopes of the corresponding terms herein are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Communication system for a rotating turret having a plurality of electronic components, the system comprising: a multi channel aggregated digital data communication link connecting between said turret and external electronics, and an internal switch located within said turret for routing said plurality of electronic components to said communication link, and an external switch for routing said external electronics to said communication link
said communication link being configured for flexible allocation of channels for flow of data between said turret and said external electronics.

2. The communication system of claim 1, wherein said internal communication switch manages respective channels for said plurality of electronic components at the turret.

3. The communication system of claim 1, wherein said external communication switch manages respective channels for said plurality of electronic components at the external electronics.

4. The communication system of claim 1, wherein some of said plurality of devices are connected to outward channels for passing data from said devices to said external electronics, and some of said plurality of devices are connected to inward channels for passing data from said external electronics to said devices.

5. The communication system of claim 1 further configured with a power connection to provide power to said plurality of devices within said turret.

6. The communication system of claim 1 wherein communication link is bidirectional.

7. The communication system of claim 1 wherein said communication link is a wired link having a slip ring connection.

8. The communication system of claim 1, wherein said communication link is a wireless link.

9. The communication system of claim 8 wherein the communication link is a LAN.

10. The communication system of claim 1, wherein the communication link is a high data rate communication link.

11. The communication system of claim 8, wherein said communication link is any one of a group comprising an IR link, a microwave link, an optical link, a LASER link, an ultrasound link, and a radio link.

12. The communication system of claim 3, wherein said power connection comprises a slip ring.

13. The communication system of claim 1, wherein said rotating turret is a turret configured to be free to carry out unlimited rotations in a given sense.

14. The communication system of claim 1, wherein said rotating turret is a turret suitable for carrying out observations from a vehicle.

15. The communication system of claim 14, wherein said vehicle is any one of a group comprising an airborne vehicle, an airborne platform, a waterborne craft, a land craft, a fixed wing aircraft, a helicopter, an unmanned aerial vehicle, a balloon, a ship, a hovercraft, a hydrofoil, a boat, a submarine, an unmanned water craft, a tank, an armored car, a reconnaissance vehicle, an autonomous land vehicle and a robot.

16. The communication system of claim 1, wherein said turret is configured within a stationary installation.

17. The communication installation of claim 16, wherein said stationary installation is any one of a group comprising a watchtower, a mast, a lookout post, a bunker, a border post, and an electronic fence.

18. The communications system of claim 1, wherein said electronic components comprise observation devices.

19. The communications system of claim 18, wherein said observation devices are one or more of a group comprising a radar device, a LASER-based observation device, a video camera, a still camera, a FLIR device, and an image intensifier.

20. The communication system of claim 1, wherein said external electronics are configured to carry out processing of image data from said electronic components.

21. The communication system of claim 1, wherein said electronic components comprise at least one observation device and at least one turret rotation device and wherein feedback control signals over said communication link use processed image data to modify a position of said turret.

22. The communication system of claim 1, wherein said aggregated communication link comprises an optical fiber.

23. The communication system of claim 17, wherein said optical fiber is a mono-mode fiber.

24. The communication system of claim 1, wherein said internal communication switch comprises multiplexing functionality for multiplexing signals from said electronic components onto respective channels.

25. The communication system of claim 1, wherein said external communication switch comprises demultiplexing functionality for routing signals from said channels to respective components.

26. The communication system of claim 1, wherein said internal communication switch comprises multiplexing functionality for routing signals from said external electronics onto respective channels for intended ones of said electronic components.

27. The communication system of claim 1, wherein said external communication switch comprises demultiplexing functionality for demultiplexing signals from said channels to be routed to said external electronics.

28. The communication system of claim 1, comprising a first communication link and a second communication link.

29. The communication system of claim 28 wherein said first communication link is a control link used for passing control signals, and wherein the said second communication link, further comprises second internal and external communication switches, and is used for passing video signals outwardly from said turret to a second external communication switch.

30. A method of communicating between a plurality of electronic components in a rotating turret and external electronics in a relatively non-rotating exterior, the method comprising:
connecting each of said plurality of electronic components to a communication switch internal to said rotating turret,
connecting said communication switch to a communication link connecting the interior of said rotating turret to said relatively non-rotating exterior,
connecting said aggregated communication link to said external electronics in said relatively non-rotating exterior, thereby to provide respectively continuous communications channels between each component, said aggregated communication link and said external electronics, and wherein said internal switch is configured for flexible allocation of resources of said communication link per electronic component.
